(19) United States
(12) Patent Application Publication
(10) Pub. No.: US 2025/0024381 A1
(43) Pub. Date: Jan. 16, 2025

(54) SYSTEMS AND METHODS FOR CONTROLLING POWER OF SIDELINK REFERENCE SIGNALS

(71) Applicant: ZTE Corporation, Shenzhen (CN)

(72) Inventors: Qi YANG, Shenzhen (CN); Chuangxin JIANG, Shenzhen (CN); Feng BI, Shenzhen (CN); Focai PENG, Shenzhen (CN); Yu PAN, Shenzhen (CN); Juan LIU, Shenzhen (CN)

(73) Assignee: ZTE Corporation, Shenzhen (CN)

(21) Appl. No.: 18/680,296

(22) Filed: May 31, 2024

Related U.S. Application Data
(63) Continuation of application No. PCT/CN2022/085336, filed on Apr. 6, 2022.

(51) Int. Cl. H04W 52/32; H04W 52/24

(52) U.S. Cl. CPC H04W 52/325; H04W 52/242

(57) ABSTRACT

Systems and methods for wireless communication systems are disclosed. In one aspect, the wireless communication method includes determining, by a first wireless communication device, a power and sending, by the first wireless communication device to a second wireless communication device in a sidelink communication, a reference signal with the power. The power is determined based on one or more sidelink parameters related to a priority level associated with the reference signal.

### CROSS-REFERENCE TO RELATED APPLICATION

This application claims the benefit of priority under 35 U.S.C. § 120 as a continuation of PCT Patent Application No. PCT/CN2022/085336, filed on Apr. 6, 2022, the disclosure of which is incorporated herein by reference in its entirety.

### TECHNICAL FIELD

The disclosure relates generally to wireless communication, including but not limited to systems and methods of controlling power of sidelink positioning reference signals.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions (NFs), have been simplified with some of them being software based so that they could be adapted according to need.

### SUMMARY

One aspect is a wireless communication method, including determining, by a first wireless communication device, a power, and sending, by the first wireless communication device to a second wireless communication device in a sidelink communication, a positioning reference signal with the power. The power is determined based on one or more sidelink parameters related to a priority level associated with the positioning reference signal.

In some arrangements, the one or more sidelink parameters are also related to capability, pathloss and a Channel Busy Ratio (CBR).

In some arrangements, the one or more sidelink parameters include at least one of the following offsets: Δ_{CBR}_{_{SL-PRS}} or Δ_{PL}_{_{SL-PRS}}. The parameter Δ_{CBR}_{_{SL-PRS}} represents an offset to P_{MAX,CBR}, and the parameter Δ_{PL}_{_{SL-PRS}} represents an offset to min(P_{SL-PRS,D}(i), P_{SL-PRS,SL}(i)), in which the parameter P_{MAX,CBR} represents a sidelink maximum transmission power of the first wireless communication device based on the CBR, the parameter P_{SL-PRS,D}(i) represents a power based on downlink pathloss of a transmission occasion of the positioning reference signal, and the parameter P_{SL-PRS,SL}(i) represents a power based on sidelink pathloss of the transmission occasion of the positioning reference signal.

In some arrangements, the offset Δ_{CBR}_{_{SL-PRS}} and the offset Δ_{PL}_{_{SL-PRS}} are each determined based on the priority level of the positioning reference signal.

In some arrangements, the priority level, for the transmission occasion of the positioning reference signal, is one of a plurality of integers indicated in Sidelink Control Information (SCI).

In some arrangements, the parameter P_{SL-PRS,D}(i) is selectively determined based on M_{RB}^{SL-PRS}(i) that represents a number of resource blocks of the transmission occasion of the positioning reference signal.

In some arrangements, the parameter P_{SL-PRS,SL}(i) is selectively determined based on PL_{SL} that represents a sidelink pathloss estimation for at least one of: unicast, groupcast, or broadcast. In some arrangements, for the groupcast and broadcast, the parameter PL_{SL} is a weighted sum of a plurality of unicast sidelink pathloss estimations between the first wireless communication device and the second wireless communication device.

In some arrangements, the one or more sidelink parameters include a parameter P_{MAX,CBR}_{_{SL-PRS}}. In some arrangements, the parameter P_{MAX,CBR}_{_{SL-PRS}} represents a sidelink maximum transmission power for the first wireless communication device based on the CBR to send the positioning reference signal.

In some arrangements, the parameter P_{MAX,CBR}_{_{SL-PRS}} is determined by at least one of the following parameters: sl-MaxTxPower, sl-MaxTxPower-PRS, or P_{CMAX}.

In some arrangements, the method further includes determining, by the first wireless communication device, that the parameter sl-MaxTxPower-PRS is provided by a higher layer, and determining, by the first wireless communication device, the parameter P_{MAX,CBR}_{_{SL-PRS}} by the parameter sl-MaxTxPower-PRS based on the priority level of the positioning reference signal and a CBR range for the positioning reference signal.

In some arrangements, the priority level, for the transmission occasion, is indicated by one of a plurality of integers indicated in Sidelink Control Information (SCI).

In some arrangements, the parameter P_{MAX,CBR}_{_{SL-PRS}} decreases as the CBR within the CBR range increases, and increases as the priority level increases.

In some arrangements, the method further includes determining, by the first wireless communication device, that the parameter sl-MaxTxPower is provided by a higher layer and the parameter sl-MaxTxPower-PRS is not provided, and determining, by the first wireless communication device, the parameter P_{MAX,CBR}_{_{SL-PRS}} as P_{MAX,CBR}_{_{SL-PRS}}=P_{MAX,CBR}+Δ_{CBR}_{_{SL-PRS}}, in which the parameter P_{MAX,CBR} represents a sidelink maximum transmission power based on the CBR of the first wireless communication device, and the offset Δ_{CBR}_{_{SL-PRS}} is an offset to the parameter P_{MAX,CBR}

In some arrangements, the parameter Δ_{CBR}_{_{SL-PRS}} is determined based on the priority level of the positioning reference signal.

In some arrangements, the priority level, for the transmission occasion of the positioning reference signal, is one of a plurality of integers indicated in Sidelink Control Information (SCI).

In some arrangements, the method further includes determining, by the first wireless communication device, that neither the parameter sl-MaxTxPower nor the parameter sl-MaxTxPower-PRS is provided, and determining, by the first wireless communication device, the parameter P_{MAX,CBR}_{_{SL-PRS}} as P_{MAX,CBR}_{_{SL-PRS}}=P_{CMAX}.

In some arrangements, the step of determining a power further includes determining, by the first wireless communication device, the power based on determining parameters P_{SL-PRS,D}(i) and P_{SL-PRS,SL}(i). The parameter P_{SL-PRS,D}(i) represents a power based on downlink pathloss of a transmission occasion of the positioning reference signal, and the parameter P_{SL-PRS,SL}(i) represents a power based on sidelink pathloss of the transmission occasion of the positioning reference signal.

In some arrangements, the parameter P_{SL-PRS,D}(i) is selectively determined based on P_{O,D}^{SL-PRS} and α_{D}^{SL-PRS}. The parameter P_{O,D}^{SL-PRS} represents the expected power of a second wireless communication device, and the parameter α_{D}^{SL-PRS} represents the downlink pathloss factor.

In some arrangements, the parameter P_{SL-PRS,SL}(i) is selectively determined based on PL_{SL} that represents a sidelink pathloss estimation for at least one of: unicast, groupcast, or broadcast, and wherein, for the groupcast and broadcast, the parameter PL_{SL} is a weighted sum of a plurality of unicast sidelink pathloss estimations between the first wireless communication device and the second wireless communication device.

In some arrangements, the parameter P_{SL-PRS,SL}(i) is selectively determined based on P_{O,SL}^{SL-PRS} and α_{SL}^{SL-PRS}. The parameter P_{O,SL}^{SL-PRS} represents the expected power of a second wireless communication device, and the parameter α_{SL}^{SL-PRS} represents the sidelink pathloss factor.

In some arrangements, the one or more sidelink parameters include at least one of the following adjustment factors: f_{D} or f_{SL}. The adjustment factor f_{D} represents a close-loop adjustment factor for the parameter P_{SL-PRS,D}(i), and the adjustment factor f_{SL} represents a close-loop adjustment factor for the parameter P_{SL-PRS,SL}(i).

In some arrangements, the adjustment factor f_{D} and adjustment factor f_{SL} are indicated by Downlink Control Information (DCI) and Sidelink Control Information (SCI), respectively.

In some arrangements, the one or more sidelink parameters include a single offset to min(P_{MAX,CBR},min(P_{SL-PRS,D}(i),P_{SL-PRS,SL}(i))), Δ_{SL-PRS}.

In some arrangements, the offset Δ_{SL-PRS} is determined based on the priority level of the positioning reference signal.

In some arrangements, the priority level, for the transmission occasion of the positioning reference signal, is one of a plurality of integers indicated in Sidelink Control Information (SCI).

In some arrangements, the parameter P_{MAX,CBR}_{_{SL-PRS}} is configured by at least one of: a higher layer, a base station, or a core network.

In some arrangements, the parameter P_{MAX,CBR}_{_{SL-PRS}} is determined based on the CBR for the positioning reference signal.

In some arrangements, the parameter P_{MAX,CBR}_{_{SL-PRS}} is determined based on a channel priority associated with the positioning reference signal.

Another aspect is a wireless communication method, including receiving, by a second wireless communication device from a first wireless communication device in a sidelink communication, a positioning reference signal with a power. The power is determined by the first wireless communication device based on one or more sidelink parameters related to capability and pathloss of the first communication device, as well as related to a priority level associated with the positioning reference signal.

Another aspect is a wireless communications apparatus including a processor and a memory. The processor is configured to read code from the memory and implement a method recited in any of the above arrangements.

Another aspect is a computer program product including a computer-readable program medium code stored thereupon, the code, when executed by a processor, causing the processor to implement a method recited in any of the above arrangements.

### BRIEF DESCRIPTION OF THE DRAWINGS

FIG. 1 illustrates an example wireless communication system in which techniques disclosed herein can be implemented, in accordance with some arrangements of the present disclosure.

FIG. 2 illustrates a block diagram of an example wireless communication system for transmitting and receiving wireless communication signals (e.g., orthogonal frequency-division multiplexing (OFDM) or orthogonal frequency-division multiple access (OFDMA) signals), in accordance with some arrangements of the present disclosure.

FIGS. 3, 4, 5, and 6 illustrate flow charts of example wireless communication processes, in accordance with some arrangements of the present disclosure.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

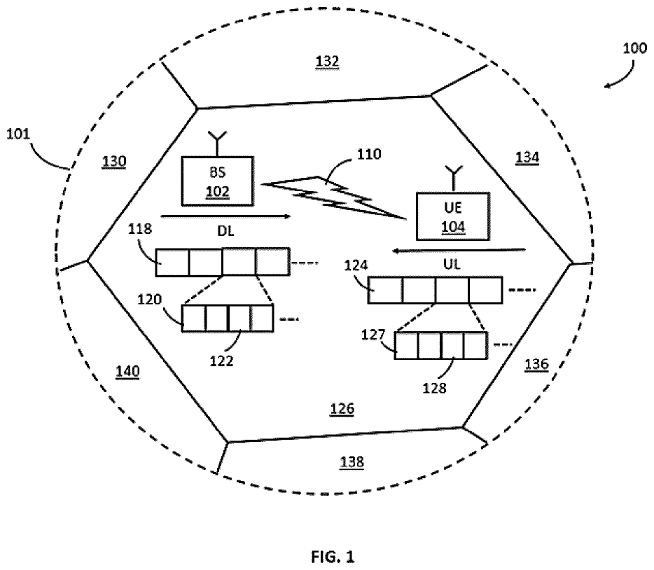

FIG. 1 illustrates an example wireless communication system 100 in which techniques disclosed herein can be implemented, in accordance with some arrangements of the present disclosure. In the following discussion, the wireless communication system 100 may implement any wireless network, such as a cellular network or a narrowband Internet of things (NB-IoT) network. Such an example system 100 includes a base station (BS) 102 (also referred to as a wireless communication node) and UE 104 (also referred to as a wireless communication device) that can communicate with each other via a communication link 110 (e.g., a wireless communication channel), and a cluster of cells 126, 130, 132, 134, 136, 138 and 140 overlaying a geographical area 101. In some examples, a network refers to one or more BSs (e.g., the BS 102) in communication with the UE 104, as well as backend entities and functions (e.g., a location management function (LMF)). In other words, the network refers to components of the system 100 other than the UE 104. In FIG. 1, the BS 102 and UE 104 are included within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various arrangements of the present solution.

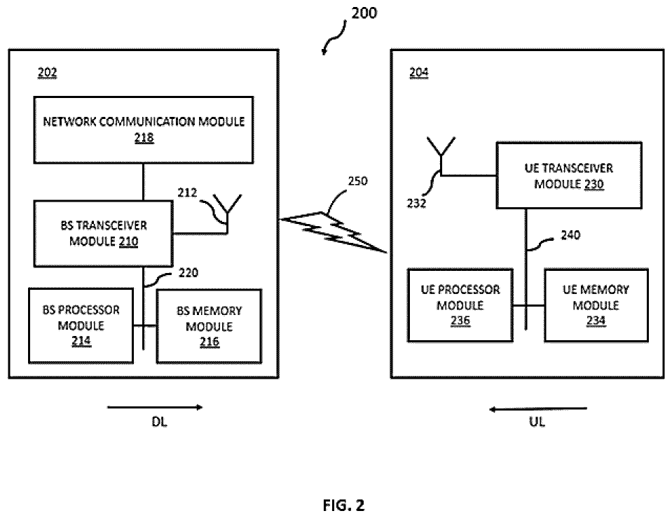

FIG. 2 illustrates a block diagram of an example wireless communication system 200 for transmitting and receiving wireless communication signals (e.g., OFDM or OFDMA signals) in accordance with some arrangements of the present disclosure. The system 200 may include components and elements configured to support known or conventional operating features that need not be described in detail herein. In one illustrative arrangement, system 200 can be used to communicate (e.g., transmit and receive) data symbols in a wireless communication environment such as the system 100 of FIG. 1, as described above.

System 200 generally includes a base station 202 (hereinafter “BS 202”) and a user equipment device 204 (hereinafter “UE 204”). The BS 202 includes a BS transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some arrangements, the UE transceiver 230 may be referred to herein as an “uplink” transceiver 230 that includes a radio frequency (RF) transmitter and a RF receiver each including circuitry that is coupled to the antenna 232. A duplex switch (not shown) may alternatively couple the uplink transmitter or receiver to the uplink antenna in time duplex fashion. Similarly, in accordance with some arrangements, the BS transceiver 210 may be referred to herein as a “downlink” transceiver 210 that includes a RF transmitter and a RF receiver each including circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232.

In some arrangements, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various arrangements, the BS 202 may be an evolved node B (eNB), a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some arrangements, a first layer may be a physical layer. In some arrangements, a second layer may be a MAC layer. In some arrangements, a third layer may be a Radio Link Control (RLC) layer. In some arrangements, a fourth layer may be a Packet Data Convergence Protocol (PDCP) layer. In some arrangements, a fifth layer may be a radio resource control (RRC) layer. In some arrangements, a sixth layer may be a Non Access Stratum (NAS) layer or an Internet Protocol (IP) layer, and the seventh layer being the other layer.

### Power Control for Sidelink Positioning Reference Signal

Positioning provides a target UE with its location information. Sidelink positioning may be used. For example, the anchor UEs, communicating with target UEs in sidelink, can be used to facilitate improvement of positioning accuracy. However, how to transmit and configure the sidelink positioning reference signal (SL-PRS) may be unavailable. In some embodiments, power control of SL-PRS transmission may be improved.

Power control has been formulated for physical sidelink control channel (PSCCH) transmission and physical sidelink shared channel (PSSCH) transmission. For positioning, anchor UEs transmit SL-PRS to a target UE, the target UE obtains the positioning measurements by measuring SL-PRS. Then, wireless dependent positioning methods can be used to calculate the target UE's location. However, the transmission power and power control of the SL-PRS may be unclear.

### Power Control Based on UE's Capability and Pathloss

In some embodiments, power control for PSSCH and PSCCH may be formulated based on UE's capability and pathloss. By exploiting the power control formula of PSSCH, several offsets are introduced to power control formula of SL-PRS, so as to eliminate the mismatch between PSSCH transmission power and SL-PRS transmission power.

For a SL-PRS transmission, a UE determines a power P_{SL-PRS}(i) in SL-PRS transmission occasion i on active SL bandwidth part (BWP) b of carrier f as:

$${P}_{SL - PRS} ( i ) = min ( {P}_{CMAX} , {P}_{MAX , CBR} + {Δ}_{{CBR}_{SL - PRS}} , min ( {P}_{SL - PRS , D} ( i ) , {P}_{SL - PRS , SL} ( i ) ) ) [ dBm ]$$

$$or$$

$${P}_{SL - PRS} ( i ) = min ( {P}_{CMAX} , {P}_{MAX , CBR} , min ( {P}_{SL - PRS , D} ( i ) , {P}_{SL - PRS , SL} ( i ) ) + {Δ}_{{PL}_{SL - PRS}} ) [ dBm ]$$

$$or$$

$${P}_{SL - PRS} ( i ) = min ( {P}_{CMAX} , {P}_{MAX , CBR} + {Δ}_{{CBR}_{SL - PRS}} , min ( {P}_{SL - PRS , D} ( i ) , {P}_{SL - PRS , SL} ( i ) ) + {Δ}_{{PL}_{SL - PRS}} ) [ dBm ]$$

where P_{CMAX} is the UE's maximum transmission power, which is dependent on the UE's capability, P_{MAX,CBR} is determined by a value of sl-MaxTxPower based on a priority level of the SL-PRS transmission and a CBR range that includes a CBR measured in slot i−N. If sl-MaxTxPower is not provided, then P_{MAX,CBR}=P_{CMAX}.

The priority of SL-PRS is indicated by a priority indicator, which value may include an integer selected from 1 to 8. And the priority indicator of SL-PRS may be configured in each SL-PRS configuration, which may be indicated by sidelink control signal (SCI).

CBR measured in slot n may be defined as the portion of sub-channels in the resource pool whose SL received signal strength indicator (RSSI) measured by the UE exceed a configured (or pre-configured) threshold sensed over a CBR measurement window [n−a,n−1], wherein a is equal to about 100 or about 100·2μ slots, according to higher layer parameter sl-Time WindowSizeCBR.

Δ_{CBR}_{_{SL-PRS}} may be designed as an offset to P_{MAX,CBR}, which is dependent on priority indicator of the SL-PRS. Each priority indicator of SL-PRS may correspond to a Δ_{CBR}_{_{SL-PRS}}. One or more offset Δ_{CBR}_{_{SL-PRS}} is/are carried on the SCI or RRC (higher layer signaling). In some embodiments, an anchor UE may send a target UE the SCI.

If dl-P0-PSSCH-PSCCH is provided,

$${P}_{SL - PRS , D} ( i ) = {P}_{O , D} + 10 {log}_{10} ( {2}^{μ} \cdot {M}_{RB}^{SL - PRS} ( i ) ) + {α}_{D} \cdot {PL}_{D} [ dBm ]$$

$$else$$

$${P}_{SL - PRS , D} ( i ) = min ( {P}_{CMAX} , {P}_{MAX , CBR} + {Δ}_{{CBR}_{SL - PRS}} ) [ dBm ]$$

where P_{O,D} is a value of dl-P0-PSSCH-PSCCH if provided, M_{RB}^{SL-PRS}(i) is a number of resource blocks for the SL-PRS transmission occasion i u is a SCS configuration, α_{D} is a value of dl-Alpha-PSSCH-PSCCH, if provided; else, α_{D}=1. PL_{D} is a downlink pathloss estimate in dB calculated by the transmission UE using reference signal (RS) for the active downlink BWP, which is the same as the downlink pathloss estimate in the physical uplink shared channel (PUSCH) power control formula except that (1) the RS resource is the one the UE uses for determining a power of a PUSCH transmission scheduled by a DCI format 0_0 in serving cell c when the UE is configured to monitor physical downlink control channel (PDCCH) for detection of DCI format 0_0 in serving cell c and (2) the RS resource is the one corresponding to the synchronization signal/physical broadcast channel (SS/PBCH) block the UE uses to obtain master information block (MIB) when the UE is not configured to monitor PDCCH for detection of DCI format 0_0 in serving cell c.

If sl-P0-PSSCH-PSCCH is provided

$${P}_{SL - PRS , SL} ( i ) = {P}_{O , SL} + 10 {log}_{10} ( {2}^{μ} \cdot {M}_{RB}^{SL - PRS} ( i ) ) + {α}_{SL} \cdot P {L}_{SL} [ dBm ]$$

$$else$$

$${P}_{SL - PRS , SL} ( i ) = min ( {P}_{CMAX} , {P}_{MAX , CBR} + {Δ}_{{CBR}_{SL - PRS}} ) [ dBm ]$$

where P_{O,SL} is a value of sl-P0-PSSCH-PSCCH, if provided. α_{SL} is a value of sl-Alpha-PSSCH-PSCCH, if provided; else, α_{SL}=1. If a SCI format scheduling the SL-PRS transmission includes a cast type indicator field indicating unicast, PL_{SL} is a unicast sidelink pathloss estimate in dB calculated by the transmission UE using reference signal. Then, the unicast sidelink pathloss estimate is calculated by PL_{SL}=referenceSignalPower−higher layer filtered RSRP, where referenceSignalPower is obtained from a PSSCH transmission power per RE summed over the antenna ports of the transmission UE, higher layer filtered across PSSCH transmission occasions using a filter configuration provided by sl-filterCoefficient, and higher layer filtered RSRP is a reference signal received power (RSRP), that is reported to the transmission UE from a target UE receiving the PSCCH-PSSCH transmission and is obtained from a PSSCH DM-RS using a filter configuration provided by sl-filterCoefficient.

If a SCI format scheduling the SL-PRS transmission includes a cast type indicator field indicating groupcast or broadcast, PL_{SL} is a groupcast/broadcast sidelink pathloss estimate in dB calculated by the transmission UE using reference signal. Then, the groupcast/broadcast sidelink pathloss estimate is a weighted sum of all the unicast sidelink pathloss estimates between the transmission UE and target UEs, that is

$$P {L}_{SL} = {ω}_{1} P {L}_{SL 1} + {ω}_{2} P {L}_{SL 2} + ⋯$$

where [PL_{SL1},PL_{SL2}, . . . ] is the unicast sidelink pathloss estimates between the transmission UE and target UEs. Each target UE reports its measured RS RSRP to transmission UE. Then, transmission UE calculates the unicast sidelink pathloss estimate between transmission UE and each target UE according to the calculation formula of the unicast sidelink pathloss estimate. [ω₁,ω₂, . . . ] is the weights of unicast sidelink pathloss estimates between the transmission UE and target UEs, which can be determined by the transmission UE. The weights satisfy ω₁+ω₂+. . . =1. For example, if the weight corresponding to the maximum unicast sidelink pathloss estimate is set to be 1, then PL_{SL}=max(PL_{SL1},PL_{SL1}, . . . ). If the weights are set to be equal, then PL_{SL}=mean(PL_{SL1},PL_{SL1}, . . . ). Δ_{PL}_{_{SL-PRS}} is an offset to min(P_{SL-PRS,D}(i), P_{SL-PRS,SL}(i)), which is dependent on priority indicator of the SL-PRS. Each priority indicator of SL-PRS is corresponding to a Δ_{PL}_{_{SL-PRS}}. One or more offset Δ_{PL}_{_{SL-PRS}} is/are carried on the SCI or RRC (higher layer signaling).

Accordingly, the SL-PRS transmission power can be flexible and controllable. In addition, this SL-PRS power control formula supports SL-PRS transmission in groupcast and broadcast.

### Designing Power Control Formula and Related Parameters

In some embodiments, for SL-PRS transmission power, another solution is to design a specific power control formula and related parameters. Based on UE's capability and pathloss, a UE determines the SL-PRS transmission power P_{SL-PRS}(i) in SL-PRS transmission occasion i on active SL BWP b of carrier f as:

$${P}_{SL - PRS} ( i ) = min ( {P}_{CMAX} , {P}_{MAX , {CBR}_{SL - PRS}} , min ( {P}_{SL - PRS , D} ( i ) , {P}_{SL - PRS , SL} ( i ) ) ) [ dBm ]$$

where P_{CMAX} is UE's maximum transmission power, which is dependent on the UE's capability.

If sl-MaxTxPower-PRS is provided, then P_{MAX,CBR}_{_{SL-PRS}} is determined by a value of sl-MaxTxPower-PRS based on a priority level of the SL-PRS transmission and a SL-PRS CBR range that includes a SL-PRS CBR measured in slot i−N.

The priority of SL-PRS is indicated by a priority indicator, which value is an integer selected from 1 to 8. And the priority indicator of SL-PRS is configured in each SL-PRS configuration, which is indicated by SCI. In some embodiments, an anchor UE may send a target UE the SCI.

SL-PRS CBR measured in slot n may be defined as the portion of SL-PRS sub-channels in the SL-PRS resource pool whose RSSI measured by the UE exceed a configured (or pre-configured) threshold sensed over a SL-PRS CBR measurement window [n−a,n−1], wherein a is equal to about 100 or about 100·2μ slots, according to higher layer parameter sl-Time WindowSizeCBR-PRS.

Through a priority indicator of SL-PRS indicated by SCI and a SL-PRS CBR measured by the transmission UE, the P_{MAX,CBR}_{_{SL-PRS}} can be determined. For example, with increasing of the SL-PRS CBR, the P_{MAX,CBR}_{_{SL-PRS}} decreases, while P_{MAX,CBR}_{_{SL-PRS}} increases as SL-PRS priority level increases.

If sl-MaxTxPower-PRS is not provided and sl-MaxTxPower is provided, then P_{MAX,CBR}_{_{SL-PRS}}=P_{MAX,CBR}+Δ_{CBR}_{_{SL-PRS}} where P_{MAX,CBR} is provided by a value of sl-MaxTxPower and Δ_{CBR}_{_{SL-PRS}} is designed as an offset to P_{MAX,CBR}, which is dependent on priority indicator of the SL-PRS. Each priority indicator of SL-PRS is corresponding to a Δ_{CBR}_{_{SL-PRS}}. One or more offset Δ_{CBR}_{_{SL-PRS}} is/are carried on the SCI or RRC (higher layer signaling).

If both of sl-MaxTxPower-PRS and sl-MaxTxPower are not provided, then P_{MAX,CBR}_{_{SL-PRS}}=P_{CMAX}.

If dl-P0-PRS is provided

$${P}_{SL - PRS , D} ( i ) = {P}_{O , D}^{SL - PRS} + 10 {log}_{10} ( {2}^{μ} \cdot {M}_{RB}^{SL - PRS} ( i ) ) + {α}_{D}^{SL - PRS} \cdot P {L}_{D} [ dBm ]$$

$$else$$

$${P}_{SL - PRS , D} ( i ) = min ( {P}_{CMAX} , {P}_{MAX , {CBR}_{SL - PRS}} ) [ dBm ]$$

where P_{O,D}^{SL-PRS} is a value of dl-P0-PRS if provided. M_{RR}^{SL-PRS}(i) is a number of resource blocks for the SL-PRS transmission occasion i. In some embodiments, M_{RB}^{SL-PRS}(i) can be related to comb number (e.g., number of SL-PRS signal with a resource block). An expression of M_{RB}^{SL-PRS}(i) can be M_{RB}^{SL-PRS}(i)/K, where K is comb number (e.g., 2, 4, 6, 12). μ is a SCS configuration. α_{D}^{SL-PRS} is a value of dl-Alpha-PRS, if provided; else, α_{D}^{SL-PRS}=1.

PL_{D} is a downlink pathloss estimate in dB calculated by the transmission UE using RS for the active downlink BWP, which is same as the downlink pathloss estimate in PUSCH power control formula except that (1) the RS resource is the one the UE uses for determining a power of a PUSCH transmission scheduled by a DCI format 0_0 in serving cell c when the UE is configured to monitor PDCCH for detection of DCI format 0_0 in serving cell c and (2) the RS resource is the one corresponding to the SS/PBCH block the UE uses to obtain MIB when the UE is not configured to monitor PDCCH for detection of DCI format 0_0 in serving cell c.

if sl-P0-PRS is provided

$${P}_{SL - PRS , SL} ( i ) = {P}_{O , SL}^{SL - PRS} + 10 {log}_{10} ( {2}^{μ} \cdot {M}_{RB}^{SL - PRS} ( i ) ) + {α}_{SL}^{SL - PRS} \cdot P {L}_{SL}^{SL - PRS} [ dBm ]$$

$$else$$

$${P}_{SL - PRS , SL} ( i ) = min ( {P}_{CMAX} , {P}_{MAX , {CBR}_{SL - PRS}} ) [ dBm ]$$

where P_{O,SL}^{SL-PRS} is a value of sl-P0-PRS, if provided. α_{SL}^{SL-PRS} is a value of sl-Alpha-PRS, if provided; else, α_{SL}^{SL-PRS}=1.

If a SCI format scheduling the SL-PRS transmission includes a cast type indicator field indicating unicast, PL_{SL}^{SL-PRS} is a unicast sidelink pathloss estimate in dB calculated by the transmission UE using reference signal. Then PL_{SL}^{SL-PRS}=referenceSignalPower−higher layer filtered RSRP, where referenceSignalPower is obtained from a SL-PRS transmission power per RE summed over the antenna ports of the transmission UE, higher layer filtered across SL-PRS transmission occasions using a filter configuration provided by sl-filterCoefficient, and higher layer filtered RSRP is a RSRP that is reported to the transmission UE from a target UE receiving the SL-PRS transmission and is obtained from a SL-PRS using a filter configuration provided by sl-filterCoefficient.

If a SCI format scheduling the SL-PRS transmission includes a cast type indicator field indicating groupcast or broadcast, PL_{SL}^{SL-PRS} is a groupcast/broadcast sidelink pathloss estimate in dB calculated by the transmission UE using reference signal. Then, the groupcast/broadcast sidelink pathloss estimate is a weighted sum of all the unicast sidelink pathloss estimates between the transmission UE and target UEs, that is

$$P {L}_{SL}^{SL - PRS} = {ω}_{1} P {L}_{SL 1}^{SL - PRS} + {ω}_{2} P {L}_{SL 2}^{SL - PRS} + ⋯$$

where [PL_{SL1}^{SL-PRS},PL_{SL2}^{SL-PRS}, . . . ] is the unicast sidelink pathloss estimates between the transmission UE and target UEs. Each target UE reports its measured SL-PRS RSRP to transmission UE. Then, transmission UE calculates the unicast sidelink pathloss estimate between transmission UE and each target UE according to the calculation formula of the unicast sidelink pathloss estimate. [ω₁,ω₂, . . . ] is the weights of unicast sidelink pathloss estimates between the transmission UE and target UEs, which can be determined by the transmission UE. The weights satisfy ω₁+ω₂+. . . =1.

If the weight corresponding to the maximum unicast sidelink pathloss estimate is set to be 1, then PL_{SL}^{SL-PRS}=max(PL_{SL1}^{SL-PRS},PL_{SL2}^{SL-PRS}, . . . ). If the weights are set to be equal, then PL_{SL}^{SL-PRS}=mean(PL_{SL1}^{SL-PRS},PL_{SL2}^{SL-PRS}, . . . ).

### Close Loop Power Control in SL-PRS Power Control Formula

In the above solutions, SL-PRS transmission power is based on the open loop power control. In order to more flexible control of the SL-PRS transmission power, the close loop power control is introduced in SL-PRS power control formula.

For a SL-PRS transmission, a UE determines a power P_{SL-PRS}(i) in SL-PRS transmission occasion i on active SL BWP b of carrier f as:

$${P}_{SL - PRS} ( i ) = min ( {P}_{CMAX} , {P}_{MAX , {CBR}_{SL - PRS}} , min ( {P}_{SL - PRS , D} ( i ) , + {f}_{D} , {P}_{SL - PRS , SL} ( i ) ) ) [ dBm ]$$

$$or$$

$${P}_{SL - PRS} ( i ) = min ( {P}_{CMAX} , {P}_{MAX , {CBR}_{SL - PRS}} , min ( {P}_{SL - PRS , D} ( i ) , {P}_{SL - PRS , SL} ( i ) ) + {f}_{SL} ) [ dBm ]$$

$$or$$

$${P}_{SL - PRS} ( i ) = min ( {P}_{CMAX} , {P}_{MAX , {CBR}_{SL - PRS}} , min ( {P}_{SL - PRS , D} ( i ) + {f}_{D} , {P}_{SL - PRS , SL} ( i ) ) + {f}_{SL} ) [ dBm ]$$

where P_{CMAX} is UE's maximum transmission power, which is dependent on the UE's capability.

If sl-MaxTxPower-PRS is provided, then P_{MAX,CBR}_{_{SL-PRS}} is determined by a value of sl-MaxTxPower-PRS based on a priority level of the SL-PRS transmission and a SL-PRS CBR range that includes a SL-PRS CBR measured in slot i−N.

The priority of SL-PRS is indicated by a priority indicator, which value is an integer selected from 1 to 8. And the priority indicator of SL-PRS is configured in each SL-PRS configuration, which is indicated by SCI. In some embodiments, an anchor UE may send a target UE the SCI.

SL-PRS CBR measured in slot n is defined as the portion of SL-PRS sub-channels in the SL-PRS resource pool whose RSSI measured by the UE exceed a (pre-)configured threshold sensed over a SL-PRS CBR measurement window [n−a,n−1], wherein a is equal to 100 or 100·μ slots, according to higher layer parameter sl-Time WindowSizeCBR-PRS.

Through a priority indicator of SL-PRS indicated by SCI and a SL-PRS CBR measured by the transmission UE, the P_{MAX,CBR}_{_{SL-PRS}} can be determined. Specifically, with increasing of the SL-PRS CBR, the P_{MAX,CBR}_{_{SL-PRS}} decreases, while P_{MAX,CBR}_{_{SL-PRS}} increases as SL-PRS priority level increases.

If sl-MaxTxPower-PRS is not provided and sl-MaxTxPower is provided, then P_{MAX,CBR}_{_{SL-PRS}}=P_{MAX,CBR}+Δ_{CBR}_{_{SL-PRS}}, where P_{MAX,CBR} is provided by a value of sl-MaxTxPower. Δ_{CBR}_{_{SL-PRS}} is designed as an offset to P_{MAX,CBR}, which is dependent on priority indicator of the SL-PRS. Each priority indicator of SL-PRS is corresponding to a Δ_{CBR}_{_{SL-PRS}}. One or more offset Δ_{CBR}_{_{SL-PRS}} is/are carried on the SCI or RRC (higher layer signaling).

If both of sl-MaxTxPower-PRS and sl-MaxTxPower are not provided, then P_{MAX,CBR}_{_{SL-PRS}}=P_{CMAX}.

If dl-P0-PRS is provided

$${P}_{SL - PRS , D} ( i ) = {P}_{O , D}^{SL - PRS} + 10 {log}_{10} ( {2}^{μ} \cdot {M}_{RB}^{SL - PRS} ( i ) ) + {α}_{D}^{SL - PRS} \cdot P {L}_{D} [ dBm ]$$

$$else$$

$${P}_{SL - PRS , D} ( i ) = min ( {P}_{CMAX} , {P}_{MAX , {CBR}_{SL - PRS}} ) [ dBm ]$$

where P_{O,D}^{SL-PRS} is a value of dl-P0-PRS if provided. M_{RB}^{SL-PRS}(i) is a number of resource blocks for the SL-PRS transmission occasion i. In some embodiments, M_{RB}^{SL-PRS}(i) can be related to comb number (e.g., number of SL-PRS signal with a resource block). An expression of M_{RB}^{SL-PRS}(i) can be M_{RB}^{SL-PRS}(i)/K, where K is comb number (e.g., 2, 4, 6, 12). μ is a SCS configuration. α_{D}^{SL-PRS} is a value of dl-Alpha-PRS, if provided; else, α_{D}^{SL-PRS}=1. PL_{D} is a downlink pathloss estimate in dB calculated by the transmission UE using RS for the active downlink BWP, which is same as the downlink pathloss estimate in PUSCH power control formula except that (1) the RS resource is the one the UE uses for determining a power of a PUSCH transmission scheduled by a DCI format 0_0 in serving cell c when the UE is configured to monitor PDCCH for detection of DCI format 0_0 in serving cell c and (2) the RS resource is the one corresponding to the SS/PBCH block the UE uses to obtain MIB when the UE is not configured to monitor PDCCH for detection of DCI format 0_0 in serving cell c. f_{D} is the adjustment factor of P_{SL-PRS,D}, which is configured by higher layer and indicated by DCI. The value of f_{D} is an integer selected from [−4,−1,0,1,4]. After receiving RS, base station sends feedback on adjustment factor f_{D} to UE based on the RSRP.

If sl-P0-PRS is provided

$${P}_{SL - PRS , SL} ( i ) = {P}_{O , SL}^{SL - PRS} + 10 {log}_{10} ( {2}^{μ} \cdot {M}_{RB}^{SL - PRS} ( i ) ) + {α}_{SL}^{SL - PRS} \cdot P {L}_{SL}^{SL - PRS} [ dBm ]$$

$$else$$

$${P}_{SL - PRS , SL} ( i ) = min ( {P}_{CMAX} , {P}_{MAX , {CBR}_{SL - PRS}} ) [ dBm ]$$

where P_{O,SL}^{SL-PRS} is a value of sl-P0-PRS, if provided. α_{SL}^{SL-PRS} is a value of sl-Alpha-PRS, if provided; else, α_{SL}^{SL-PRS}=1.

If a SCI format scheduling the SL-PRS transmission includes a cast type indicator field indicating unicast, PL_{SL}^{SL-PRS} is a unicast sidelink pathloss estimate in dB calculated by transmission UE using reference signal. Then, PL_{SL}^{SL-PRS}=referenceSignalPower−higher layer filtered RSRP, where referenceSignalPower is obtained from a SL-PRS transmission power per RE summed over the antenna ports of the transmission UE, higher layer filtered across SL-PRS transmission occasions using a filter configuration provided by sl-filterCoefficient, and higher layer filtered RSRP is a RSRP that is reported to the transmission UE from a target UE receiving the SL-PRS transmission and is obtained from a SL-PRS using a filter configuration provided by sl-filterCoefficient.

If a SCI format scheduling the SL-PRS transmission includes a cast type indicator field indicating groupcast or broadcast, PL_{SL}^{SL-PRS} is a groupcast/broadcast sidelink pathloss estimate in dB calculated by the transmission UE using reference signal. Then, the groupcast/broadcast sidelink pathloss estimate is a weighted sum of all the unicast sidelink pathloss estimates between the transmission UE and target UEs, that is

$$P {L}_{SL}^{SL - PRS} = {ω}_{1} P {L}_{SL 1}^{SL - PRS} + {ω}_{2} P {L}_{SL 2}^{SL - PRS} + ⋯$$

where [PL_{SL1}^{SL-PRS},PL_{SL2}^{SL-PRS}, . . . ] is the unicast sidelink pathloss estimates between the transmission UE and target UEs. Each target UE reports its measured SL-PRS RSRP to transmission UE. Then, transmission UE calculates the unicast sidelink pathloss estimate between transmission UE and each target UE according to the calculation formula of the unicast sidelink pathloss estimate. [ω₁,ω₂, . . . ] is the weights of unicast sidelink pathloss estimates between the transmission UE and target UEs, which can be determined by the transmission UE. The weights satisfy ω₁+ω₂+. . . =1. For example, if the weight corresponding to the maximum unicast sidelink pathloss estimate is set to be 1, then PL_{SL}^{SL-PRS}=max(PL_{SL1}^{SL-PRS},PL_{SL2}^{SL-PRS}, . . . ). If the weights are set to be equal, then PL_{SL}^{SL-PRS}=mean(PL_{SLA}^{SL-PRS},PL_{SL2}^{SL-PRS}, . . . ). f_{SL} is the adjustment factor of P_{SL-PRS,SL}, which is configured in DCI format 3-0 and indicated by SCI. The value of f_{SL} is an integer selected from [−4,−1,0,1,4].After receiving SL-PRS, target UE sends feedback on adjustment factor f_{SL} to transmission UE based on the SL-PRS RSRP.

Accordingly, the SL-PRS transmission power is more precise due to introduction of the close loop power control. The adjustment factor f_{SL} is configured in DCI 3-0 and only suitable to mode 1 in sidelink. Another way to configure f_{SL} is to configure f_{SL} by higher layer and indicated by SCI. In this way, the adjustment factor f_{SL} can be suitable to both of mode 1 and mode 2.

### One Offset to SL-PRS Power Control Based on PSSCH Power Control

In some embodiments, for a SL-PRS transmission power, only one offset to SL-PRS power control based on PSSCH power control is introduced. For example, a UE determines a SL-PRS transmission power P_{SL-PRS}(i) in SL-PRS transmission occasion i on active SL BWP b of carrier f as:

$${P}_{SL - PRS} ( i ) = min ( {P}_{CMAX} , min ( {P}_{MAX , CBR} , min ( {P}_{SL - PRS , D} ( i ) , {P}_{SL - PRS , SL} ( i ) ) ) + {Δ}_{SL - PRS} ) [ dBm ]$$

where P_{CMAX} is UE's maximum transmission power, which is dependent on the UE's capability. P_{MAX,CBR} is determined by a value of sl-MaxTxPower based on a priority level of the SL-PRS transmission and a CBR range that includes a CBR measured in slot i−N. if sl-MaxTxPower is not provided, then P_{MAX,CBR}=P_{CMAX}. The priority of SL-PRS is indicated by a priority indicator, which value is an integer selected from 1 to 8. And the priority indicator of SL-PRS is configured in each SL-PRS configuration, which is indicated by SCI. In some embodiments, an anchor UE may send a target UE the SCI.

CBR measured in slot n is defined as the portion of sub-channels in the resource pool whose SL RSSI measured by the UE exceed a (pre-)configured threshold sensed over a CBR measurement window [n−a,n−1], wherein a is equal to 100 or 100·2μ slots, according to higher layer parameter sl-Time WindowSizeCBR.

If dl-P0-PSSCH-PSCCH is provided

$${P}_{SL - PRS , D} ( i ) = {P}_{O , D} + 10 {log}_{10} ( {2}^{μ} \cdot {M}_{RB}^{SL - PRS} ( i ) ) + {α}_{D} \cdot P {L}_{D} [ dBm ]$$

$$else$$

$${P}_{SL - PRS , D} ( i ) = min ( {P}_{CMAX} , {P}_{MAX , CBR} + {Δ}_{{CBR}_{SL - PRS}} ) [ dBm ]$$

where P_{O,D} is a value of dl-P0-PSSCH-PSCCH if provided. M_{RB}^{SL-PRS}(i) is a number of resource blocks for the SL-PRS transmission occasion i In some embodiments, M_{RB}^{SL-PRS}((i) can be related to com b number (e.g., number of SL-PRS signal with a resource block). An expression of M_{RB}^{SL-PRS}(i) can be M_{RB}^{SL-PRS}(i)/K, where K is comb number (e.g., 2, 4, 6, 12). μ is a SCS configuration. α_{d} is a value of dl-Alpha-PSSCH-PSCCH, if provided; else, α_{D}=1. PL_{D} is a downlink pathloss estimate in dB calculated by the transmission UE using RS for the active downlink BWP, which is same as the downlink pathloss estimate in the PUSCH power control formula except that (1) the RS resource is the one the UE uses for determining a power of a PUSCH transmission scheduled by a DCI format 0_0 in serving cell c when the UE is configured to monitor PDCCH for detection of DCI format 0_0in serving cell c and (2) the RS resource is the one corresponding to the SS/PBCH block the UE uses to obtain MIB when the UE is not configured to monitor PDCCH for detection of DCI format 0_0 in serving cell c.

If sl-P0-PSSCH-PSCCH is provided

$${P}_{SL - PRS , SL} ( i ) = {P}_{O , SL} + 10 {log}_{10} ( {2}^{μ} \cdot {M}_{RB}^{SL - PRS} ( i ) ) + {α}_{SL} \cdot P {L}_{SL} [ dBm ]$$

$$else$$

$${P}_{SL - PRS , SL} ( i ) = min ( {P}_{CMAX} , {P}_{MAX , CBR} + {Δ}_{{CBR}_{SL - PRS}} ) [ dBm ]$$

where P_{O,SL} is a value of sl-P0-PSSCH-PSCCH, if provided. α_{SL} is a value of sl-Alpha-PSSCH-PSCCH, if provided; else, α_{SL}=1.

If a SCI format scheduling the SL-PRS transmission includes a cast type indicator field indicating unicast, PL_{SL} is a unicast sidelink pathloss estimate in dB calculated by the transmission UE using reference signal. Then, the unicast sidelink pathloss estimate is calculated by PL_{SL}=referenceSignalPower−higher layer filtered RSRP, where referenceSignalPower is obtained from a PSSCH transmission power per RE summed over the antenna ports of the transmission UE, higher layer filtered across PSSCH transmission occasions using a filter configuration provided by sl-filterCoefficient, and higher layer filtered RSRP is a RSRP, that is reported to the transmission UE from a target UE receiving the PSCCH-PSSCH transmission and is obtained from a PSSCH DM-RS using a filter configuration provided by sl-filterCoefficient.

If a SCI format scheduling the SL-PRS transmission includes a cast type indicator field indicating groupcast or broadcast, PL_{SL} is a groupcast/broadcast sidelink pathloss estimate in dB calculated by the transmission UE using reference signal. Then, the groupcast/broadcast sidelink pathloss estimate is a weighted sum of all the unicast sidelink pathloss estimates between the transmission UE and target UEs, that is

$$P {L}_{SL} = {ω}_{1} P {L}_{SL 1} + {ω}_{2} P {L}_{SL 2} + ⋯$$

where [PL_{SL1},PL_{SL2}, . . . ] is the unicast sidelink pathloss estimates between the transmission UE and target UEs. Each target UE reports its measured RS RSRP to transmission UE. Then, transmission UE calculates the unicast sidelink pathloss estimate between transmission UE and each target UE according to the calculation formula of the unicast sidelink pathloss estimate. [ω₁,ω₂, . . . ] is the weights of unicast sidelink pathloss estimates between the transmission UE and target UEs, which can be determined by the transmission UE. The weights satisfy ω₁+ω₂+. . . =1. For example, if the weight corresponding to the maximum unicast sidelink pathloss estimate is set to be 1, then PL_{SL}=max(PL_{SL1},PL_{SL1}, . . . ). If the weights are set to be equal, then PL_{SL}=mean(PL_{SL1},PL_{SL1}, . . . ).

Δ_{SL-PRS} is an offset to min(P_{MAX,CBR},min(P_{SL-PRS,D}(i),P_{SL-PRS,SL}(i))), which is dependent on priority indicator of the SL-PRS. Each priority indicator of SL-PRS is corresponding to a Δ_{SL-PRS}. One or more offset Δ_{SL-PRS} is/are carried on the SCI or RRC (higher layer signaling).

Accordingly, only one offset is introduced based on priority indicator of SL-PRS. Although the compensation between SL-PRS transmission power and PSSCH power control is rough, the overhead to configure the offset is low. According to adjusting the offset, SL-PRS transmission power can be modified timely, which facilitates to decrease the latency of positioning. Also, separately from the PSSCH transmission power control, designing SL-PRS power control is beneficial to improve the positioning accuracy.

### Additional Definitions for P_{MAX,CBR}_{_{SL-PRS}}

Other definition for parameter P_{MAX,CBR}_{_{SL-PRS}} in SL-PRS power control formula may be used. For example, P_{MAX,CBR}_{_{SL-PRS}} can be configured by higher layer or network (e.g., base station, a core network). For example, P_{MAX,CBR}_{_{SL-PRS}} can be related with a SL-PRS CBR.

If sl-MaxTxPower-PRS is not provided and sl-MaxTxPower is provided, then P_{MAX,CBR}_{_{SL-PRS}} can be obtained as following table:

TABLE 1

| SL-PRS CBR | P_{MAX,CBR}_{_{SL-PRS}} |
|---|---|
| SL-PRS CBR < 0.1 | a₀* P_{MAX,CBR} |
| 0.1 ≤ SL-PRS CBR ≤ 0.4 | a₁* P_{MAX,CBR} |
| SL-PRS CBR > 0.4 | a₂* P_{MAX,CBR} |

a₀, a₁ and a₂ are positive numbers. They can be either greater than one or less than one. When a₀/a₁/a₂ is larger than one, that means the corresponding P_{MAX,CBR}_{_{SL-PRS}} is larger than P_{MAX,CBR}, while the corresponding P_{MAX,CBR}_{_{SL-PRS}} is less than P_{MAX,CBR} when a₀/a₁/a₂ is less than one. The values of a₀, a₁ and a₂ can be determined by transmission UE.

If both of sl-MaxTxPower-PRS and sl-MaxTxPower are not provided, then P_{MAX,CBR}_{_{SL-PRS}} can be obtained as following table:

TABLE 2

| SL-PRS CBR | P_{MAX,CBR}_{_{SL-PRS}} |
|---|---|
| SL-PRS CBR < 0.1 | b₀* P_{CMAX} |
| 0.1 ≤ SL-PRS CBR ≤ 0.4 | b₁* P_{CMAX} |
| SL-PRS CBR > 0.4 | b₂* P_{CMAX} |

b₀, b₁ and b₂ are positive numbers and are less than one, whose values can be determined by transmission UE. In some embodiments, P_{MAX,CBR}_{_{SL-PRS}} can be related with a channel priority.

If sl-MaxTxPower-PRS is not provided and sl-MaxTxPower is provided, then P_{MAX,CBR}_{_{SL-PRS}} can be obtained as following table:

TABLE 3

| Channel priority | P_{MAX,CBR}_{_{SL-PRS}} |
|---|---|
| SL-PRS with a highest priority level than other | c₀* P_{MAX,CBR} |
| channel(s)/signal(s) | |
| SL-PRS with a lower priority level than SSB/PSBCH but | c₁* P_{MAX,CBR} |
| higher priority level than other channel(s)/signal(s) | |
| SL-PRS with a lowest priority level than other | c₂* P_{MAX,CBR} |
| channel(s)/signal(s) | |

c₀, c₁ and c₂ are positive numbers. They can be either greater than one or less than one. When c₀/c₁/c₂ is larger than one, that means the corresponding P_{MAX,CBR}_{_{SL-PRS}} is larger than P_{MAX,CBR}, while the corresponding P_{MAX,CBR}_{_{SL-PRS}} is less than P_{MAX,CBR} when c₀/c₁/c₂ is less than one. The values of c₀, c₁ and c₂ can be determined by transmission UE. The channel priority can be configured/indicated by higher layer or core network (e.g., an LMF).

If both of sl-MaxTxPower-PRS and sl-MaxTxPower are not provided, then P_{MAX,CBR}_{_{SL-PRS}} can be obtained as following table:

TABLE 4

| Channel priority | P_{MAX,CBR}_{_{SL-PRS}} |
|---|---|
| SL-PRS with a highest priority level than other | d₀* P_{CMAX} |
| channel(s)/signal(s) | |
| SL-PRS with a lower priority level than SSB/PSBCH but | d₁* P_{CMAX} |
| higher priority level than other channel(s)/signal(s) | |
| SL-PRS with a lowest priority level than other | d₂* P_{CMAX} |
| channel(s)/signal(s) | |

d₀, d₁ and d₂ are positive numbers and are less than one, whose values can be determined by transmission UE.

In some embodiments, several offsets to SL-PRS power control based on PSSCH power control formula may be introduced. The offsets and the priority of SL-PRS are defined. Furthermore, SL-PRS power control in groupcast and broadcast may also be used.

In some embodiments, a power control formula and related parameters for SL-PRS power control may be designed. For example, the SL-PRS CBR and priority of SL-PRS are defined. SL-PRS power control in groupcast and broadcast may also be used.

In some embodiments, the close loop power control in SL-PRS power control formula may be used. The SL-PRS CBR and priority of SL-PRS and related parameters in SL-PRS power control formula are defined. SL-PRS power control in groupcast and broadcast may also be used. Two adjustment factors are defined for close loop power control.

In some embodiments, only one offset to SL-PRS power control based on PSSCH power control formula may be used. The offset and the priority of SL-PRS are defined. And SL-PRS power control in groupcast and broadcast may be used.

For parameter P_{MAX,CBR}_{_{SL-PRS}} in SL-PRS power control formula, three kinds of definition are provided.

FIGS. 7-11 illustrate flow charts of example wireless communication processes, in accordance with some arrangements. Although each of the flow charts show a certain order, arrangements are not limited thereto, and the order of operations of the processes may be changed in any suitable manner.

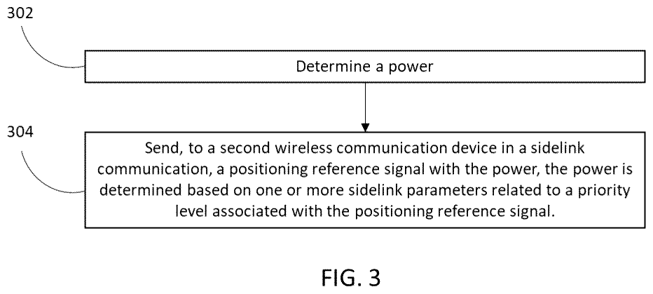

FIG. 3 illustrates a flow chart of an example wireless communication process 300 according to some arrangements. The process 300 is performed by the UE (e.g., anchor UE). The process 300 includes determining a power (302), and sending, a second wireless communication device (e.g., target UE), in a sidelink communication, a positioning reference signal with the power (304). The power is determined based on one or more sidelink parameters related to a priority level associated with the positioning reference signal.

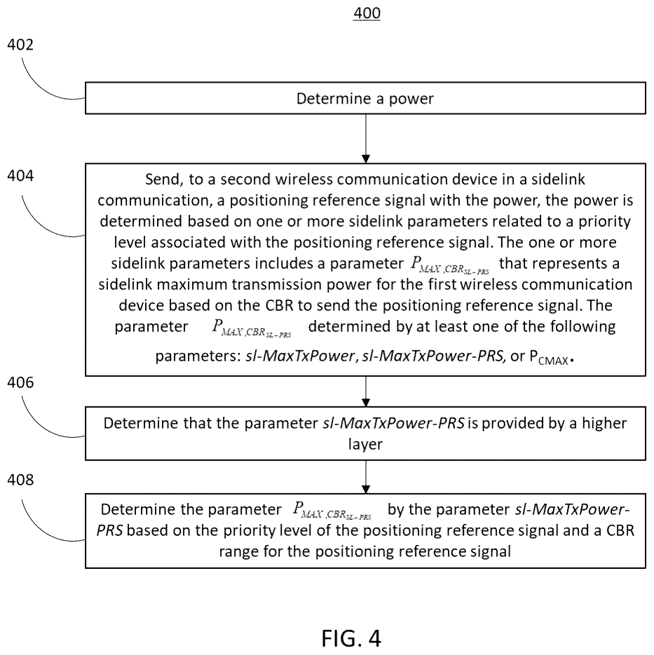

FIG. 4 illustrates a flow chart of an example wireless communication process 400 according to some arrangements. The process 400 is performed by the UE (e.g., anchor UE). The process 400 includes determining a power (402), and sending, a second wireless communication device (e.g., target UE), in a sidelink communication, a positioning reference signal with the power (404). The power is determined based on one or more sidelink parameters related to a priority level associated with the positioning reference signal. The one or more sidelink parameters include a parameter, P_{MAX,CBR}_{_{SL-PRS}}. The parameter P_{MAX,CBR}_{_{SL-PRS}} represents a sidelink maximum transmission power for the first wireless communication device based on the CBR to send the positioning reference signal. The parameter P_{MAX,CBR}_{_{SL-PRS}} is determined by at least one of the following parameters: sl-MaxTxPower, sl-MaxTxPower-PRS, or P_{CMAX}. The process 400 includes determining that the parameter sl-MaxTxPower-PRS is provided by a higher layer (406) and determining the parameter P_{MAX,CBR}_{_{SL-PRS}} by the parameter sl-MaxTxPower-PRS based on the priority level of the positioning reference signal and a CBR range for the positioning reference signal (408).

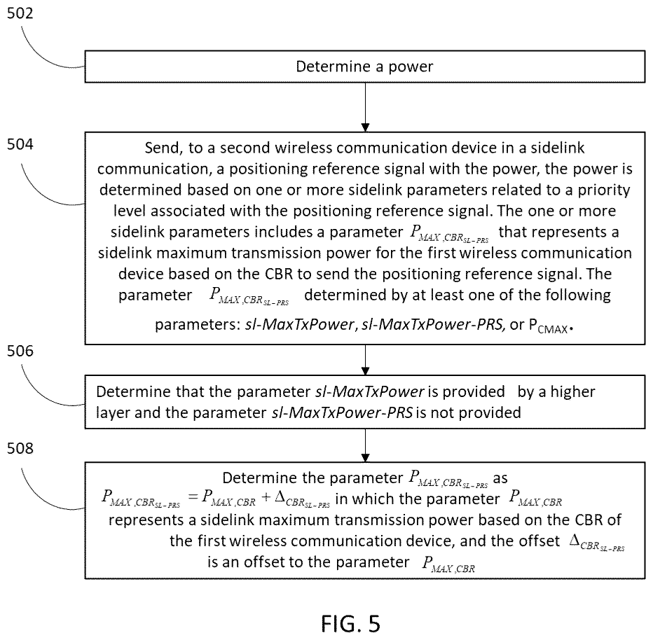

FIG. 5 illustrates a flow chart of an example wireless communication process 500 according to some arrangements. The process 500 is performed by the UE (e.g., anchor UE). The process 500 includes determining a power (502), and sending, a second wireless communication device (e.g., target UE), in a sidelink communication, a positioning reference signal with the power (504). The power is determined based on one or more sidelink parameters related to a priority level associated with the positioning reference signal. The one or more sidelink parameters include a parameter, P_{MAX,CBR}_{_{SL-PRS}}. The parameter P_{MAX,CBR}_{_{SL-PRS}} represents a sidelink maximum transmission power for the first wireless communication device based on the CBR to send the positioning reference signal. The parameter P_{MAX,CBR}_{_{SL-PRS}} is determined by at least one of the following parameters: sl-MaxTxPower, sl-MaxTxPower-PRS, or P_{CMAX}. The process 500 includes determining that the parameter sl-MaxTxPower is provided by a higher layer and the parameter sl-MaxTxPower-PRS is not provided (506). The process 500 includes determining the parameter P_{MAX,CBR}_{_{SL-PRS}} as P_{MAX,CBR}_{_{SL-PRS}}=P_{MAX,CBR}+Δ_{CBR}_{_{SL-PRS}}, in which the parameter P_{MAX,CBR} represents a sidelink maximum transmission power based on the CBR of the first wireless communication device, and the offset Δ_{CBR}_{_{SL-PRS}} is an offset to the parameter P_{MAX,CBR} (508).

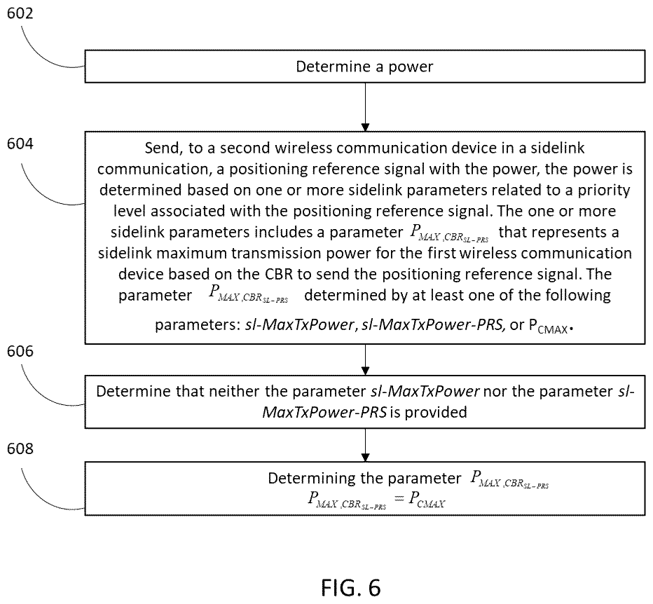

FIG. 6 illustrates a flow chart of an example wireless communication process 600 according to some arrangements. The process 600 is performed by the UE (e.g., anchor UE). The process 600 includes determining a power (602), and sending, a second wireless communication device (e.g., target UE), in a sidelink communication, a positioning reference signal with the power (604). The power is determined based on one or more sidelink parameters related to a priority level associated with the positioning reference signal. The one or more sidelink parameters include a parameter, P_{MAX,CBR}_{_{SL-PRS}}. The parameter P_{MAX,CBR}_{_{SL-PRS}} PRS represents a sidelink maximum transmission power for the first wireless communication device based on the CBR to send the positioning reference signal. The parameter P_{MAX,CBR}_{_{SL-PRS}} is determined by at least one of the following parameters: sl-MaxTxPower, sl-MaxTxPower-PRS, or P_{CMAX}. The process 600 includes determining that neither the parameter sl-MaxTxPower nor the parameter sl-MaxTxPower-PRS is provided (606). The process 600 includes determining the parameter P_{MAX,CBR}_{_{SL-PRS}} as P_{MAX,CBR}_{_{SL-PRS}}=P_{CMAX} (608).

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one arrangement can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules. However, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the arrangements described in this disclosure will be readily apparent to those skilled in the art, and the general principles defined herein can be applied to other arrangements without departing from the scope of this disclosure. Thus, the disclosure is not intended to be limited to the arrangements shown herein, but is to be accorded the widest scope consistent with the novel features and principles disclosed herein, as recited in the claims below.

1. A wireless communication method, comprising:
determining, by a first wireless communication device, a power; and
sending, by the first wireless communication device to a second wireless communication device, a sidelink positioning reference signal (SL PRS) with the power,
wherein the power is determined based on one or more sidelink parameters including: a first sidelink parameter related to a priority level and a Channel Busy Ratio (CBR), a second sidelink parameter related to capability, and at least one sidelink parameter related to pathloss.

2. The wireless communication method of claim 1, wherein the first sidelink parameter includes a parameter, P_{MAX,CBR}_{_{SL-PRS}},
wherein the parameter P_{MAX,CBR}_{_{SL-PRS}} represents a sidelink maximum transmission power for the first wireless communication device based on the CBR to send the SL PRS.

3. The wireless communication method of claim 2, wherein the parameter P_{MAX,CBR}_{_{SL-PRS}} is determined by at least one of the following parameters: sl-MaxTxPower-PRS, or P_{CMAX}.

4. The wireless communication method of claim 3, further comprising:
determining, by the first wireless communication device, that the parameter sl-MaxTxPower-PRS is provided by a higher layer; and
determining, by the first wireless communication device, the parameter P_{MAX,CBR}_{_{SL-PRS}} by the parameter sl-MaxTxPower-PRS based on the priority level that is associated with the SL PRS and a CBR range.

5. The wireless communication method of claim 4, wherein the priority level is indicated by one of a plurality of integers indicated in Sidelink Control Information (SCI).

6. The wireless communication method of claim 3, further comprising:
determining, by the first wireless communication device, that the parameter sl-MaxTxPower-PRS is not provided; and
determining, by the first wireless communication device, the parameter P_{MAX,CBR}_{_{SL-PRS}} as P_{MAX,CBR}_{_{SL-PRS}}=P_{CMAX}.

7. The wireless communication method of claim 1, wherein the at least one parameter related to pathloss includes: P_{SL-PRS,D}(i) and P_{SL-PRS,SL}(i),
wherein the parameter P_{SL-PRS,D}(i) represents a power based on downlink pathloss, and the parameter P_{SL-PRS,SL}(i) represents a power based on sidelink pathloss.

8. The wireless communication method of claim 7, wherein the parameter P_{SL-PRS,D}(i) is selectively determined based on P_{O,D}^{SL-PRS} and α_{D}^{SL-PRS}; and wherein the parameter P_{O,D}^{SL-PRS} represents an expected power, and the parameter α_{D}^{SL-PRS} represents the downlink pathloss factor.

9. The wireless communication method of claim 7, wherein the parameter P_{SL-PRS,SL}(i) is selectively determined based on PL_{SL} that represents a sidelink pathloss estimation for unicast transmission of the SL PRS.

10. The wireless communication method of claim 9, wherein the parameter P_{SL-PRS,SL}(i) is selectively determined base on P_{O,SL}^{SL-PRS} and α_{SL}^{SL-PRS}; and wherein the parameter P_{O,SL}^{SL-PRS} represents an expected power, and the parameter α_{SL}^{SL-PRS} represents a sidelink pathloss factor.

11. The wireless communication method of claim 9, wherein the PL_{SL} is calculated using referenceSignalPower and higher layer filtered RSRP, where referenceSignalPower is obtained from a SL PRS transmission power per resource element (RE), and higher layer filtered RSRP is a reference signal received power (RSRP) that is obtained from the SL PRS and reported to the first wireless communication device from the second wireless communication device receiving the SL PRS.

12. The wireless communication method of claim 2, wherein the parameter P_{MAX,CBR}_{_{SL-PRS}} is configured by a base station.

13. A first wireless communication device, comprising:
at least one processor configured to:
determine a power; and
send, via a transmitter to a second wireless communication device, a sidelink positioning reference signal (SL PRS) with the power,
wherein the power is determined based on one or more sidelink parameters including: a first sidelink parameter related to a priority level and a Channel Busy Ratio (CBR), a second sidelink parameter related to capability, and at least one sidelink parameter related to pathloss.

14. A second wireless communication device, comprising:
at least one processor configured to:
receive, via a receiver from a first wireless communication device, a sidelink positioning reference signal (SL PRS) with a power,
wherein the power is determined by the first wireless communication device based on one or more sidelink parameters including: a first sidelink parameter related to a priority level and a Channel Busy Ratio (CBR), a second sidelink parameter related to capability, and at least one sidelink parameter related to pathloss.

15. A wireless communication method, comprising:
receiving, by a second wireless communication device from a first wireless communication device, a sidelink positioning reference signal (SL PRS) with a power,
wherein the power is determined by the first wireless communication device based on one or more sidelink parameters including: a first sidelink parameter related to a priority level and a Channel Busy Ratio (CBR), a second sidelink parameter related to capability, and at least one sidelink parameter related to pathloss.

16. The wireless communication method of claim 15, wherein the first sidelink parameter includes a parameter, P_{MAX,CBR}_{_{SL-PRS}}, and
wherein the parameter P_{MAX,CBR}_{_{SL-PRS}} represents a sidelink maximum transmission power for the first wireless communication device based on the CBR to send the SL PRS.

17. The wireless communication method of claim 16, wherein the parameter P_{MAX,CBR}_{_{SL-PRS}} is determined by at least one of the following parameters: sl-MaxTxPower-PRS, or P_{CMAX}.

18. The wireless communication method of claim 17, wherein:
the parameter sl-MaxTxPower-PRS is provided by a higher layer; and
the parameter P_{MAX,CBR}_{_{SL-PRS}} is determined by the parameter sl-MaxTxPower-PRS based on the priority level that is associated with the SL PRS and a CBR range.

19. The wireless communication method of claim 18, wherein the priority level is indicated by one of a plurality of integers indicated in Sidelink Control Information (SCI).

20. The wireless communication method of claim 17, wherein:
the parameter sl-MaxTxPower-PRS is not provided; and
the parameter P_{MAX,CBR}_{_{SL-PRS}} is determined as P_{MAX,CBR}_{_{SL-PRS}}=P_{CMAX}.
